(19) United States
(12) Patent Application Publication
(10) Pub. No.: US 2025/0110903 A1
(43) Pub. Date: Apr. 3, 2025

(54) HARDWARE ACCELERATION OF DICTIONARY COMPRESSION

(71) Applicant: Intel Corporation, Santa Clara, CA (US)

(72) Inventors: Dongsheng Liang, Shanghai (CN); Junyuan Wang, Shanghai (CN); Xiaoyan Bo, Shanghai (CN); Yuze Xiao, Shanghai (CN); Haoxiang Sun, Shanghai (CN); Weigang Li, Shanghai (CN); Marian Horgan, Mallow (IE); Fei Wang, Shannon (IE); John J. Browne, Limerick (IE); Laurent Coquerel, Raheen (IE); Giovanni Cabiddu, Shannon (IE); Vijay Sundar Selvamani, Dublin (IE); Steven Linsell, Wootton (GB); Karthikeyan Gopal, Chennai (IN); Deepika Ranganatha, Tuam (IE)

(73) Assignee: Intel Corporation, Santa Clara, CA (US)

(21) Appl. No.: 18/978,180

(22) Filed: Dec. 12, 2024

(30) Foreign Application Priority Data
Jun. 28, 2024 (WO) PCT/CN2024/102279
Nov. 7, 2024 (WO) PCT/CN2024/130516

(51) Int. Cl. G06F 13/28

(52) U.S. Cl. CPC G06F 13/28; G06F 2213/28

(57) ABSTRACT

A hardware accelerator device is provided with accelerator hardware to perform dictionary compressions in hardware based on a request from an application executed by a processor device coupled to the hardware accelerator device to compress data for the application.

### RELATED APPLICATIONS

This application claims the benefit of and priority from International Patent Application Serial No. PCT/CN2024/102279, filed Jun. 28, 2024, entitled “DICTIONARY DATA COMPRESSION ACCELERATION” and from International Patent Application Serial No. PCT/CN2024/130516, filed Nov. 7, 2024, entitled “HARDWARE ACCELERATION OF DICTIONARY COMPRESSION,” the disclosures of which are considered part of and hereby incorporated by reference in their entireties in the disclosure of this application.

### BACKGROUND

A datacenter may include one or more platforms each comprising at least one processor and associated memory modules. Each platform of the datacenter may facilitate the performance of any suitable number of processes associated with various applications running on the platform. These processes may be performed by the processors and other associated logic of the platforms. Each platform may additionally include I/O controllers, such as network adapter devices, which may be used to send and receive data on a network for use by the various applications.

### BRIEF DESCRIPTION OF THE DRAWINGS

FIG. 1 illustrates a block diagram of components of a datacenter in accordance with certain embodiments.

FIG. 2 is a simplified block diagram of an example platform including a hardware accelerator.

FIG. 3 is a simplified block diagram illustrating an example logical stack for a hardware accelerator used by one or more applications in an example computing platform.

FIG. 4 is a simplified block diagram illustrating a hardware accelerator.

FIG. 5 is a graph illustrating example compression ratio results.

FIG. 6 is a simplified block diagram illustrating an example dictionary compression.

FIG. 7 is a simplified block diagram illustrating an example dictionary compression performed by an example hardware accelerator.

FIG. 8 is a simplified block diagram illustrating an example verification of a dictionary compression using hardware of a hardware accelerator device.

FIGS. 9A-9B are simplified block diagrams illustrating an example accelerator device configured to detect errors in a dictionary.

FIGS. 10A-10B are simplified block diagrams illustrating an example accelerator device configured to detect errors in a dictionary provided through an example dictionary frame.

FIGS. 11A-11B are simplified flow diagrams illustrating example techniques for detecting errors in a dictionary.

FIGS. 12A-12B are simplified flow diagrams illustrating example techniques for detecting errors in a dictionary provided through an example dictionary frame.

FIG. 13 illustrates a block diagram of an example processor device in accordance with certain embodiments.

Like reference numbers and designations in the various drawings indicate like elements.

### DETAILED DESCRIPTION

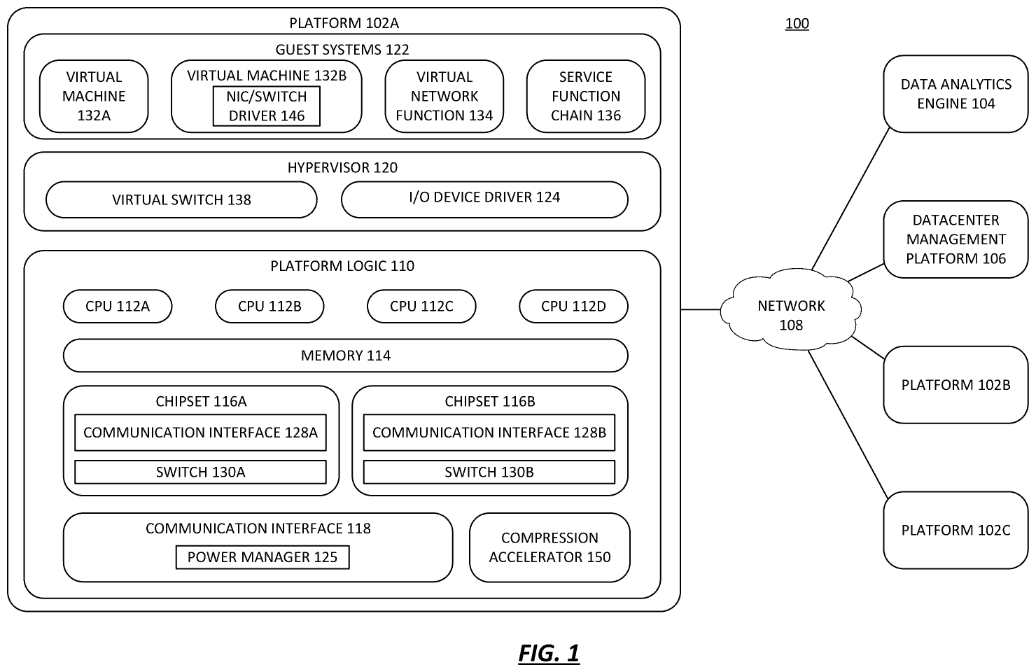

FIG. 1 illustrates a block diagram of components of a datacenter 100 in accordance with certain embodiments. In the embodiment depicted, datacenter 100 includes a plurality of platforms 102, data analytics engine 104, and datacenter management platform 106 coupled together through network 108. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. The platform may be logically or physically subdivided into clusters and these clusters may be enhanced through specialized networking accelerators (e.g., a smart NIC, infrastructure processing unit (IPU), etc.), among other example enhancements.

Each platform 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch). In still other examples, the platform or portions of the platform (including an integrated (e.g., on-die) hardware accelerator (e.g., 150) may be integrated within other computing systems and form factors, including personal computers, set top boxes, gaming systems, smart appliances, IoT systems, smart phones, vehicle onboard systems, among other examples.

CPUs 112 may each comprise any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removably coupled to platform 102. Although four CPUs are shown, a platform 102 may include any suitable number of CPUs. In some implementations, applications to be executed using the CPU (or other processors) may include physical layer management applications, which may enable customized software-based configuration of the physical layer of one or more interconnect used to couple the CPU (or related processor devices) to one or more other devices in a datacenter system.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPU 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may each comprise memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. Each chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on each CPU.

Chipsets 116 may each include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (e.g., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, and others, which may each alternatively or collectively apply the general principles and/or specific features discussed herein. Switch 130 may be a physical or virtual (e.g., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features. Other controllers may also be provided and/or integrated in blocks of the platform. For instance, as discussed in more detail herein, a hardware accelerator device 150 may include power consumption monitoring and management logic (e.g., implemented in hardware and/or firmware) to rate limit use of the hardware accelerator based on tenant power consumption, among other examples.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 may include a group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (e.g., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. Each platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports).

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the data system 100 may be coupled together in any suitable manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

In some implementations, the data system 100 may include one or more hardware accelerator devices (e.g., 150) to assist with tasks of the data system 100 and to “accelerate” certain common tasks of the system 100 and thereby increase the overall efficiency of the system and applications executed on the system (e.g., from a latency, bandwidth, or power perspective). In one example, an accelerator device 150 may be provided on the data system 100, with hardware-implemented logic to perform a set of functions or algorithms commonly used within the data system. As an example, the accelerator 150 may include circuitry to perform compression/decompression, encryption/decryption, networking, data transformation, memory management, machine learning-related tasks (e.g., training, inferences, neural network modeling, etc.), and other tasks. In some examples, the accelerator 150 may be included on a system on chip (SoC) device, a plug-in card, an IPU or smart networking device, among other examples. SoC devices, as referred to herein, may include devices implemented on a same package or same die and including various hardware components or blocks to implement a particular system. In some implementations, the accelerator device 150 may include features similar to a QuickAssist™ accelerator device, Huawei™ SmartCompression™ or SmartDedupe™, hardware, among other examples.

The exponential growth of data-and compute-intensive workloads such as artificial intelligence (AI), analytics, high-performance storage, and cloud application services has placed increasing demands on a data system's CPU(s) and other hardware (e.g., memory, I/O, etc.). As an example, managing encrypted data resources has become common practice. Further, applications that involve compression and encryption of data in a single pass can significantly tie up processing resources and add data-flow bottlenecks, leading to increased latency. Indeed, even standard compression algorithms can consume significant CPU resources. To address these and other example issues, an accelerator may be included (e.g., as a standalone accelerator device, built-in (integrated) accelerator, or add-in card), through which certain computationally intensive operations (e.g., symmetric and asymmetric cryptography, data compression/decompression operations, artificial intelligence, reversible data transforms, etc.) can be offloaded from the CPU, allowing computational resources to be reallocated to allow the CPU to perform other tasks more efficiently, potentially enhancing overall system performance, efficiency, and power across various use cases, among other example advantages.

In some implementations, an accelerator device, which may include one or multiple blocks of accelerator hardware, may be used (e.g., at the direction of a CPU, hypervisor, or other logic used to implement an application) to perform one or more jobs for an application. In some implementations, the accelerator device may be offered in a system on chip (SoC) or other platform for utilization within a datacenter or other distributed computing environment, where multiple clients, applications, services, or other tenants may call upon and use the accelerator device and its hardware in connection with one or more jobs. Indeed, the platform may balance or share the concurrent use of the accelerator device and its resources between the multiple tenants. In some implementations, the resources and functionality of the accelerator device may be shared utilizing virtualization techniques such as single root I/O virtualization (SR-IOV), Scalable I/O Virtualization (SIOV), or other example techniques. In some implementations, the balancing and even monetization of a datacenter service offering the accelerator technology may utilize the metrics measuring the use of the accelerator device. As an example, a Service Level Agreements

(SLA) may be defined for a tenant, which may include a guarantee that use of a given resource or collection of resources (e.g., including the accelerator hardware) may be made available. For instance, an amount of guaranteed throughput (e.g., measured in Gbps) of an accelerator device may be offered to and guaranteed to a given accelerator device. In one example, other or additional metrics may be measured and tracked to determine a level of utilization of various computing resources, such as accelerator devices, such as the utilization of PCI bandwidth, firmware (e.g., microengines (MEs) of the accelerator device, accelerator hardware modules or blocks (or “slices”), and receive/response buffers (or “ring pairs”), which may be mapped to different virtual functions, virtual devices, or other tenants, among other examples.

While metrics measuring throughput and resource usage (e.g., cycle counts, etc.) may be useful in the management and control of a platform and its components, in some implementations, power consumption may be a superior metric to assess overall utilization of components of a platform and control access to these components (e.g., through throttling or rate-limiting, etc.). Indeed, bandwidth consumption (e.g., measuring the amount of data that is input to or output from a component) may miss instances where the complexity or volume of processing used to consume data that is input or output from the component. For instance, a cryptographic or compression accelerator may utilize different algorithms to perform a corresponding task on an amount of data, and the power consumption may vary considerably based on the algorithm performed, despite providing the same level of throughput (e.g., PCIe in/out bandwidth) and processing time. Indeed, power consumption may be utilized as the basis for tenant's utilization costs associated with the use of one or more components (e.g., hardware accelerators) within a platform.

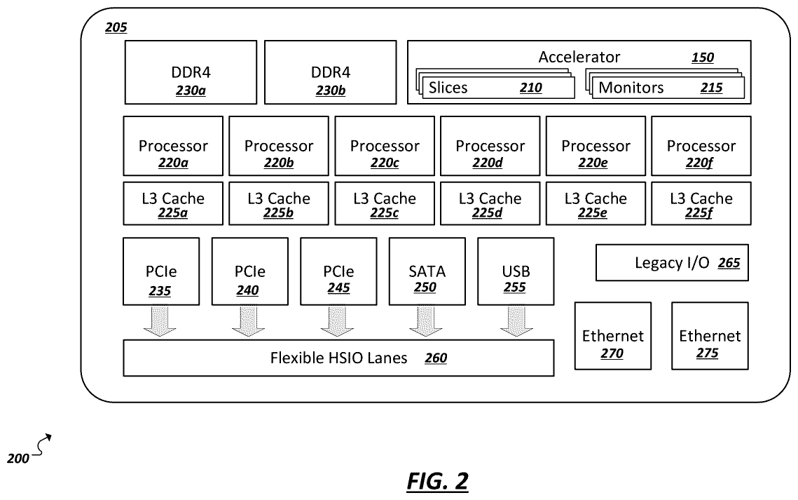

Turning to FIG. 2, a simplified block diagram 200 is shown of an example processing device 205, such as implemented in a system on chip (SoC), processor device, chiplet, motherboard, or another computing platform. In this example, an improved hardware accelerator 150 may be provided, which includes power monitoring circuitry to measure and record, on a per-tenant level, the amount of power consumed by the tenant through its use of the hardware accelerator 150. In cases, where the hardware accelerator (e.g., 150) is integrated within a processing device (e.g., 205), power consumed specifically through use of the hardware accelerator (e.g., separate from the power consumed by other components of the processing device 205 or the processing device overall, may be measured and utilized, for instance, to perform rate limiting, throttling, or other control tasks associated with the use of the processing device 205. For instance, as opposed to throttling a given processing device 205 due to its overall power use (e.g., which may be high given excessive use of an integrated hardware accelerator 150), measuring power consumption specifically at the hardware accelerator (and/or other specific sub-components of the processor device) may allow the individual components (e.g., hardware accelerator 150) responsible for the processor device's high power usage to be throttled, rather than the entire processor, among other example use cases.

Returning to the example of FIG. 2, an example hardware accelerator 150 may include circuitry to implement a set of hardware-accelerated functions. In some implementations, accelerator circuitry may be implemented as multiple “slices” 210 of accelerator hardware, which may each be used (e.g., in parallel with other slices) to perform jobs, which may be assigned to the hardware accelerator 150. The hardware accelerator may additionally include a collection of monitors (e.g., 215) to measure metrics of the hardware at each of the hardware slices 210 and other components of the hardware accelerator 150 in order to determine (e.g., at a per-job or per-tenant level) the performance metrics of the example hardware accelerator, among other example features and uses. The hardware accelerator 150 allows for various operations to be offloaded from the general purpose processing cores (e.g., CPUs), which may otherwise be called upon to perform such operations (e.g., through the execution of corresponding software or firmware code), such as compression operations, decompression operations, and encryption operations, which applications and hosts may call upon. In this example, the data processing system 205 may include one more processor devices 220a-f with corresponding cache blocks 225a-f (e.g., level 3 (L3) cache). System memory 230a-b (e.g., implemented using DDR4 memory blocks) may be provided and further used by the processors 225a-f and hardware accelerator 150, among other elements of the data processing system. In some implementations, source and destination buffers may be implemented in system memory 230a-b. I/O circuitry may be provided to couple components to the memory 203a-b. Additional I/O circuitry (e.g., 235, 240, 245, 250, 255, 265, 270, 275) may be provided to allow the data processing system 205 to interface and communicate with external devices, for instance, over flexible high speed I/O (HSIO) lanes 260.

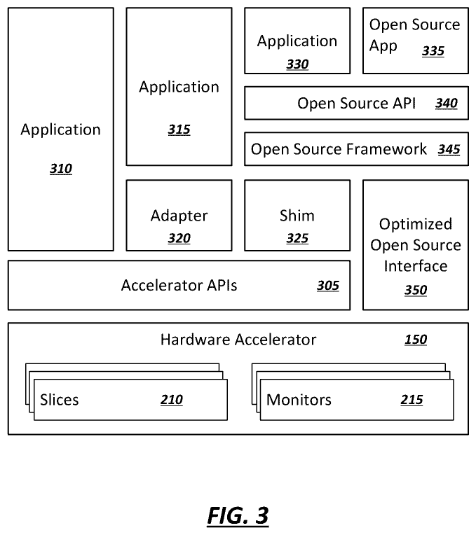

Turning to the simplified block diagram 300 in FIG. 3, a representation is shown of a logic stack for implementing applications (e.g., 310, 315, 330, 335), which may leverage the functionality of an example hardware accelerator 150. In some implementations, one or more application programming interfaces (APIs) (e.g., 305) may be provided to allow applications to request the hardware accelerator to perform, using the hardware circuitry of the hardware accelerator 150, one or more accelerated tasks in association with one or more threads or jobs associated with an application. Some applications (e.g., 310) may directly access the accelerator API 305, while other applications (e.g., 315, 330, 335, etc.) may utilize adapters (e.g., 320), shims (e.g., 325), open source APIs and adapters (e.g., 340, 345, 350), among other example modules, application architectures, and implementations.

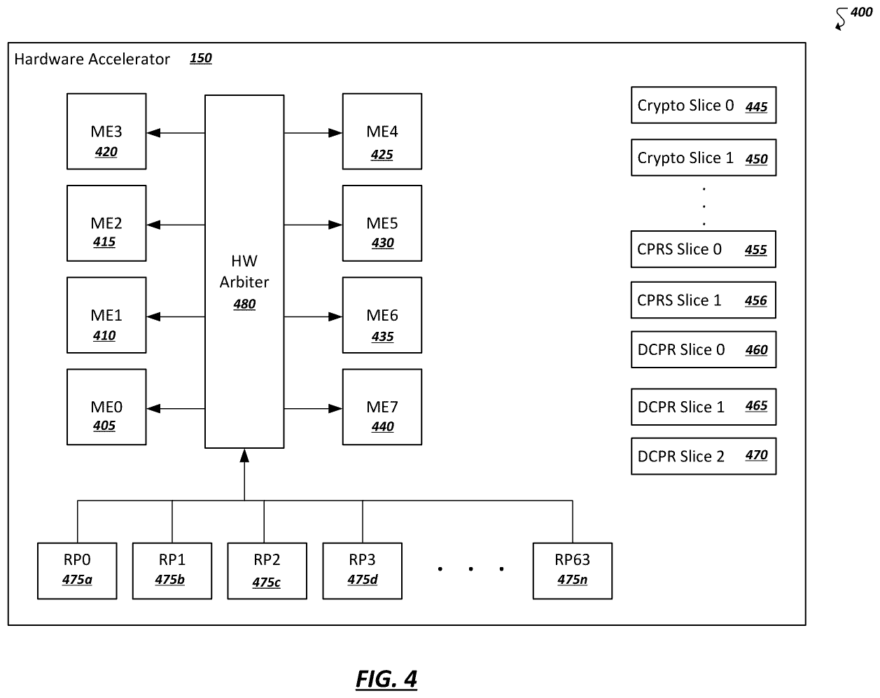

Turning to the simplified block diagram 400 of FIG. 4, an example architecture is shown of an example implementation of a hardware accelerator 150. In this example, a collection of multiple microengines (MEs) (e.g., 405, 410, 415, 420, 425, 430, 435, 440) are provided. A microengine (ME) may include processing circuitry and memory, the processing circuitry configured to execute various firmware images loaded onto the ME. A firmware image loaded onto an ME may provide the logic executable by the ME to manage the performance of various jobs using one or more of the various accelerator hardware slices (e.g., 445, 450, 455, 460, 465, 470, etc.) provided on the hardware accelerator 150. An arbiter block 480 may be provided to organize and direct the assignment of individual jobs to various collections of one or more MEs (e.g., 405, 410, 415, 420, 425, 430, 435, 440) and one or more hardware slices (e.g., 445, 450, 455, 460, 465, 470, etc.) of the hardware accelerator.

In the example of FIG. 4, an example hardware accelerator is provided with various acceleration hardware to perform various cryptography and compression/decompression tasks. For instance, a subset of the hardware slices (e.g., 445, 450) may implement cryptography acceleration, another subset of the hardware slices (e.g., 455, 456) data compression, and another subset of hardware slices (e.g., 460, 465, 470) corresponding decompression. In this example, a subset of the compression hardware slices (e.g., 455) and decompression hardware slices (e.g., 460) (e.g., which may be included within the same accelerator) may be configured to perform tasks to complete dictionary compressions/decompressions in accordance with the acceleration and offloading of such tasks at the hardware accelerator 150. MEs may be loaded with firmware, in this example, to perform cryptographic operations (and use cryptography slices 445, 450) or alternatively be loaded with different firmware (e.g., at boot time) to perform compression/decompression operations. In some runtime sessions, different MEs may be loaded with cryptography firmware and others with compression/decompression firmware in this example. In other instances, all of the MEs may be loaded with either cryptography firmware (e.g., when it is expected that all workloads will be cryptography-focused (with compression and decompression slices remaining idle during the session)) or compression/decompression firmware (e.g., when the workloads during the session are expected to be compression and decompression), among other examples. In other example implementations, all of the hardware slices may be instances of the same block of accelerator hardware, allowing multiple tenants to simultaneously access and use respective hardware slices to perform similar types of operations (e.g., cryptography, graphics processing, network management, memory management, compression/decompression, AI inferences, etc.). In such implementations, each of the MEs may be loaded with the same or similar firmware to manage jobs performed using the hardware slice instances, among other example implementations.

Continuing with the example of FIG. 4, one or more interfaces may be provided (e.g., ports compatible with an interconnect protocol (e.g., PCIe, CXL, NVLink, UCIe, etc.)) to allow the hardware accelerator 150 to couple one or more other devices. For instance, one or multiple CPU nodes may couple to and communicate with the hardware accelerator in connection with applications, services, or microservices executed on the processors, with jobs being sent to the hardware accelerator where appropriate or desired to offload tasks that may otherwise be performed using generalized processing hardware of the CPU nodes and/or software executed by the CPUs, among other examples. The hardware accelerator 150 may include memory to implement a collection of queues or buffers, such as ring buffer pairs (e.g., 475a-n). A ring buffer may be associated with or mapped to a particular ME and/or a particular tenant associated with a given job to be executed using the MEs and hardware slices of the hardware accelerator 150. A ring pair may include a first buffer, or request buffer, to accept requests from a tenant associated with a job. Requests held in the request buffer may point to memory (e.g., system memory, DDR, etc.) where data to be processed using the hardware accelerator is stored. A ring pair may additionally include a response buffer to hold the responses or results of processing of requests by the hardware accelerator 150. The responses in the response buffer correspond to requests in the request buffer of the same ring pair. The responses may also include pointers to memory (e.g., DDR) where result payload data is stored.

When a job is received at the hardware accelerator, it may be assigned to one or more MEs (e.g., 415), which may use corresponding firmware and accelerator hardware slices (e.g., 455) to generate completions of various requests associated with a job (e.g., a dictionary compression job). A ring pair (e.g., 475d) may be mapped to the job and the requests for handling by the assigned ME and completions/results generated by the ME (using the hardware slices) may be entered in the ring pair 475d. In addition to holding requests and responses in transactions between the hardware accelerator and a tenant, ring pairs may also be used, in some implementations, to store metrics measured at the hardware accelerator, associated with the execution of a job, such as the amount of data throughput in and/or out of the hardware accelerator associated with a job or tenant, the duration of a job or associated tenant's use or “ownership” of an ME or hardware slice, among other example metrics. In other implementations, a separate table, register, or other data structure may be provided (e.g., in addition to the ring pair) to store metrics associated with an RP, tenant, or job, which may be accessed (e.g., by a corresponding ME) in connection with rate limiting, SLA implementations, etc. based on these metrics.

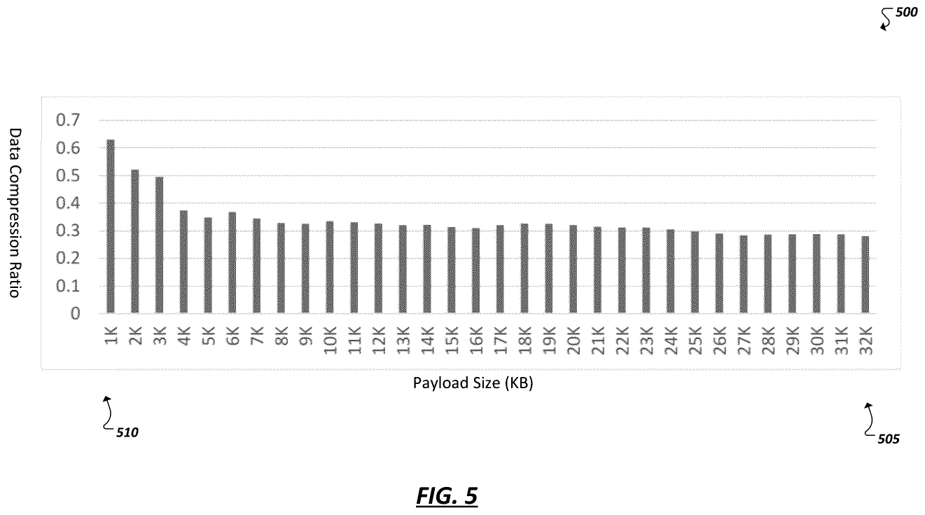

Data compression (DC) ratio is a critical performance metric in the context of data compression, where a good DC ratio corresponds to greater savings in data storage, reduced payload sizes in data transactions, and improved network bandwidth based on the data compression. However, it is not easy to get a better DC ratio in cases where the payload size is small, as the possible data match length is relatively short when payload sizes are small and data match computing is a computing intensive job. A variety of applications and use cases utilize relatively small data payloads, such as database applications, edge applications, sensor applications, among other examples. As an example, FIG. 5 is a graph 500 illustrating the range of DC ratio values that may be achieved using the same data compression algorithm. For instances, taking the same data compression algorithm (e.g., level 1 dynamic deflate compression) and the same test file input, data compression of a 32 KB payload yields a DC ratio of 28% (at 505), whereas a 1 KB payload yields a substantially worse DC ratio of 63% (more than two times greater than for the 32KB test) (at 510). A higher DC ratio means worse performance, as a higher DC ratio corresponds to less data size reduction from the data compression.

Relatively small payload sizes are quite popular and subject to data compression, such as enterprise database services, among other examples. In an improved system, a hardware accelerator is provided to implement dictionary compression, which can help improve DC ratios particularly for small size payload significantly. However, such software-based approaches may yield poor performance suffering from high latency and low throughput (e.g., due to no specific CPU ISA adapted for dictionary compression tasks), among other example issues. Software-based approaches may also suffer from high CPU utilization and costs (e.g., compression techniques, such as dictionary compression, are resource intensive jobs for traditional CPUs and compute platforms). Indeed, a focus on improving the data compression level of compression algorithms is likely to result in still further demands on conventional systems and may result in sacrificing the overall performance of a system for what may be only marginal DC ratio improvements for small payload sizes, among other example issues.

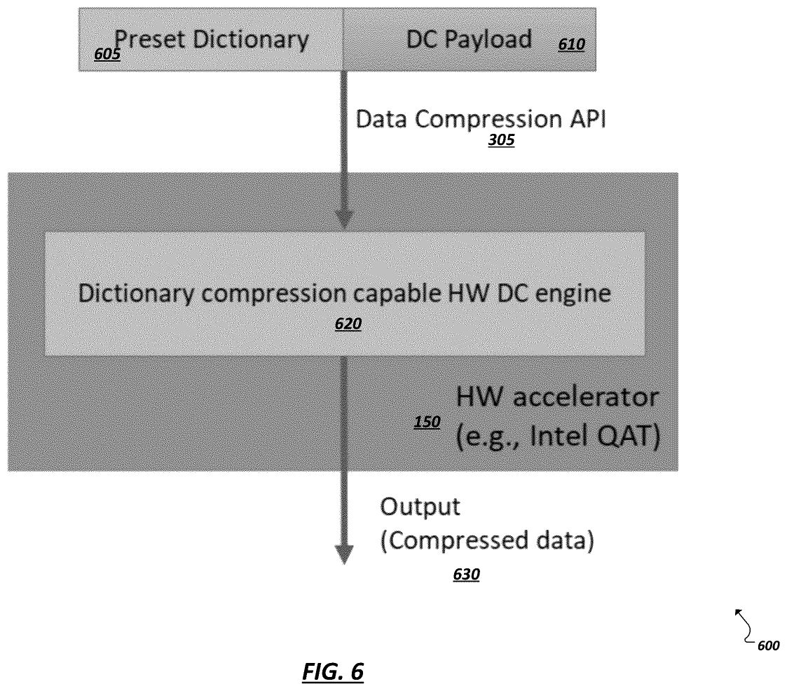

A data compression hardware accelerator may be provided to implement dictionary compression leveraging the accelerators hardware engine to perform the longest possible match in a non-empty history buffer at an early stage, which can improve the DC ratio and the overall data compression performance while offloading CPU workload. For instance, turning to the simplified block diagram 600 of FIG. 6, a preset dictionary 605 and payload 610 for data compression may be provided as a request to a data compression API 305 by an application to compress the payload using dictionary compression (and generate a compressed data output 630). The request is provided through the API 305 to a data compression hardware accelerator 150, which includes circuitry 620 for implementing dictionary compression in hardware. The circuitry may include circuitry capable of being used in both dictionary compression algorithms and other non-dictionary compression algorithms. For instance, firmware may be loaded into the hardware accelerator directing the hardware accelerator to utilize the compression hardware blocks resident on the hardware accelerator to perform a dictionary compression algorithms. In other transactions, firmware of the hardware accelerator may direct the use of some of these same compression hardware blocks used in the dictionary compression in the performance of a different (e.g., non-dictionary) compression, among other examples. The enhanced data compression hardware accelerator 150 may utilize its dictionary compression logic 620 to improve compression ratios realized by the hardware accelerator, particularly for shorter input sequence compression use cases. Accordingly, a CPU may offload more specialized compression to the hardware accelerator 150 and improve the overall data compression service performance of the platform.

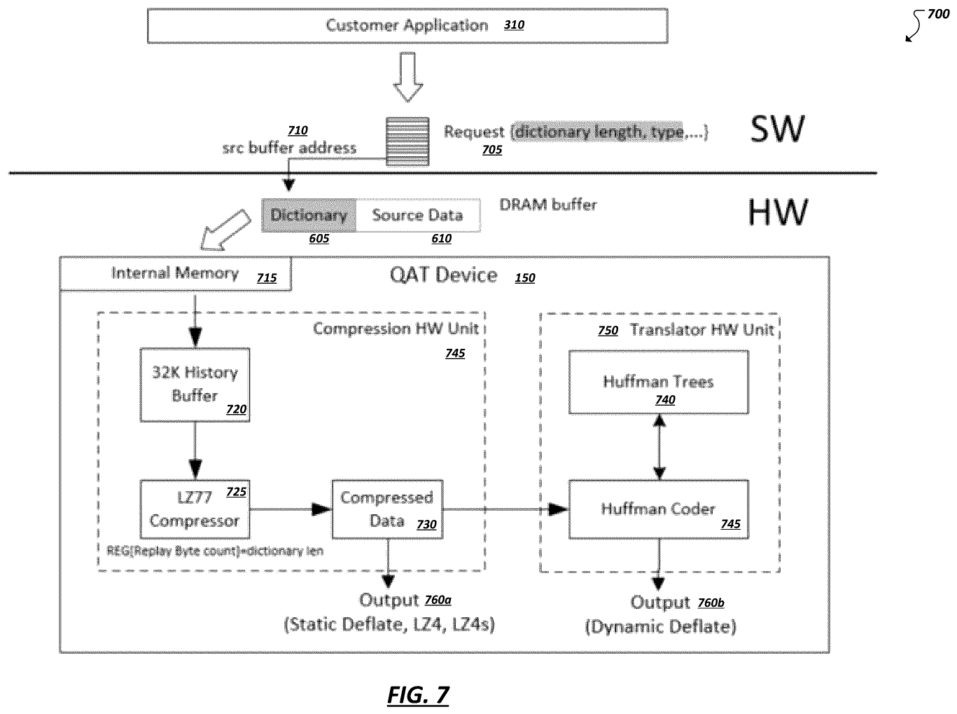

Turning to FIG. 7, a simplified block diagram 700 is shown illustrating an example implementation of dictionary compression on a hardware accelerator device 150. An application or an entity associated with the client or its application may generate a dictionary intended for use in the compression of given target data payload(s) the application intends to compress. For instance, a dictionary training tool may be utilized with sample or real data associated with the application to develop dictionaries corresponding to the application. In other cases, a pre-existing dictionary may be selected (e.g., among many possible dictionaries) based on a belief or analysis that the dictionary is likely to be suitable to data of a particular application, among other examples. Dictionaries may be developed that are adapted to particular data of an application and these dictionaries may be furnished by the application in its request for the hardware accelerator to perform a dictionary compression. As shown in the example of FIG. 7, an application 310 may send a compression (or decompression) request 705 to a hardware accelerator 150 through an API associated with the hardware accelerator 150. The request may identify that the compression is to be a dictionary compression (e.g., according to a particular compression algorithm, level, or scheme supported by the hardware of the hardware accelerator). The request 705 may also point to (or include) the target data to be compressed and the dictionary to be used in the dictionary compression of the target data. For instance, the request may include a pointer to the target data in a memory (e.g., host memory) and another pointer to the dictionary in a memory (e.g., the same or different memory system where the target data is stored), which the hardware accelerator may fetch (e.g., using a direct memory access or other technique) for use in the hardware's performance of the compression.

In one example, the dictionary 605 and target data 610 may be copied to local memory 715 of the hardware accelerator 150 (or directly onto the accelerator (e.g., within a queue or register)) for use by the hardware accelerator compression and decompression hardware. Firmware of the hardware accelerator 150 may identify the request and orchestrate the performance of the compression of the target data 610 using hardware circuitry blocks (e.g., 720, 725, 730, 735, 740, etc.) of the hardware accelerator and the provided dictionary 605. In some implementations, the request 705 may include information such as an identifier or pointer to the dictionary, the dictionary's length, the dictionary's type, and the dictionary checksum (e.g., for an integrity verification), among other example information. The request may also provide details or requests identifying the specific dictionary compression algorithm to be performed, among other example information. The hardware accelerator firmware 150 may parse the contents of such a compression request 705 to configure and direct the performance of a given dictionary compression algorithm by configuring the hardware blocks (e.g., 720, 725, 730, 735, 740) of the hardware accelerator to appropriately perform the tasks of the compression algorithm. In one example, a hardware compression engine (e.g., 745, 750) may be provided and the dictionary data (pointed to in the request 705 and copied to internal memory 715) may be loaded into history buffer 720 and hash tables, and processed using the one or more appropriate blocks of the compression circuitry (e.g., LZ77 compressor hardware 725) to implement the requested compression algorithm through hardware of the hardware accelerator. In this example, the compressor hardware (e.g., 720, 725, 730, 735, 740) utilizes the dictionary 605 provided or identified in the request 705 to complete the compressions and substantially improve a traditional compression ratio (e.g., realized by the hardware accelerator when performing non-dictionary compressions, etc.), as the compressor is able to perform the longest possible match in a non-empty history buffer at an early stage in the overall compression, among other examples. A compression output (e.g., 760a-b) is generated by the hardware accelerator and returned to the requesting host from the hardware accelerator in response to the request or moved to another computer elements (e.g., another hardware accelerator) for further processing, among other example implementations.

Continuing with the above example, the hardware accelerator 150, in addition to being called upon to compress various data, may also be requested (e.g., by another application executed on the same or a different host coupled to and using the hardware accelerator), to decompress a piece of data (e.g., which was compressed by the same dictionary-compression-enabled hardware accelerator, a different instance of such a hardware accelerator, or software-based dictionary compressor, etc.). In such examples, a request may be received by the hardware accelerator for the offloading of the decompression from a host CPU (e.g., which might otherwise use a software-based dictionary compressor). In the decompression phase, the hardware accelerator may identify (e.g., in a corresponding decompression request received at the hardware accelerator 150 at an API) that a given dictionary is to be used in a dictionary decompression of compressed target data (which was compressed using the given dictionary). The decompression request may include a pointer to the given dictionary (e.g., in host memory). In some implementations, the hardware accelerator may cache the dictionary in its internal memory 715 (e.g., after retrieving the dictionary during another decompression or a compression using the given dictionary). The decompression request may also identify the target data to be decompressed (e.g., via a pointer) and the target data may be loaded (e.g., via DMA) to the internal memory 715 of the hardware accelerator 150 with the given dictionary to be accessed by decompression hardware blocks of the hardware accelerator to perform the decompression. Firmware of the hardware accelerator 150 may identify a particular dictionary decompression algorithm to be used in the decompression and direct the decompression blocks of the hardware accelerator to perform the specified decompression algorithm (e.g., as specified in the decompression request).

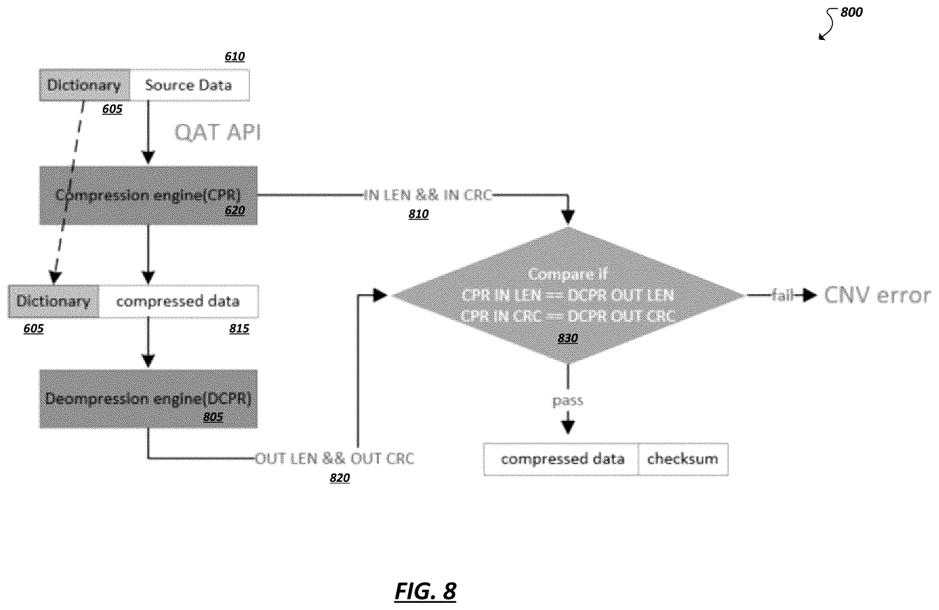

In some implementations, the hardware accelerator device 150 may include additional circuitry that may be leveraged during dictionary compression to perform a verification of the compression results (e.g., performing a compress and verify). The verification may include running a decompression of data compressed by the hardware accelerator in connection with the compression (e.g., quickly after the compression concludes and before the compression result is sent out from the hardware accelerator). Turning to FIG. 8, a simplified block diagram 800 is shown illustrating example flow of a verification performed by a hardware accelerator in connection with compression of target data 610. For instance, decompression hardware 805 of the hardware accelerator may be configured (e.g., by firmware) to perform a decompression that is the counterpart of the compression being performed on given target data. To perform verification, the same dictionary 605 used in the compression of the target data 610 is also loaded into a decompression engine 805 of the hardware accelerator (e.g., to prime a matched hash table and history buffer in a manner similar to the counterpart compression engine (e.g., 620)). In one example, a checksum (e.g., a cyclic redundancy check (CRC) value) and length (e.g., 810) are calculated for the target data that is to be input into the compression engine. The decompression engine may record these values and perform a decompression of the compression engine's result (e.g., 815). When the work of the compression engine and decompression engine are complete, a checksum and length (e.g., 820) of the decompression engine's result may be calculated and compared (at 830) with the checksum and length for the input target data compressed by the compression engine to validate and verify the integrity of the compression engine's result, among other example implementations and features.

In some instances, the data corruption resulting from the compression of data using a dictionary compression algorithm can go undetected, for instance, due to corruption of the dictionary data used in the dictionary compression. Preserving user data integrity may be critical to providing compression as a service, in some implementations. In the case of a compression of the dictionary content, the resulting compressed data (compressed using corrupted dictionary data) would be uncompressible by either compression hardware or supportive software. In some implementations, a hardware accelerator including compression and/or decompression circuitry (e.g., as in the examples above) to handle dictionary-based compression or decompression operations may be further provided with logic to detect corruption in dictionary data and prevent the use of corrupted dictionary content in its compression and decompression operations. Similar techniques and logic may be employed in firmware of an accelerator device to detect dictionary data corruption, among other example implementations.

Dictionary compression/decompression may involve an application (e.g., accessing and using the functionality of a compression acceleration hardware) providing a dictionary to the compression acceleration hardware's internal history buffer for use by the accelerator in performing dictionary-based compression or decompression. However, the dictionary used during the compression operation must be the same dictionary used during the decompression operation. If the dictionaries are different, it may be impossible to retrieve the original cleartext data from the compressed data resulting in silent data corruption. Furthermore, a dictionary provided and used in a compression/decompression operation can be updated at any time by an application, with the possibility of a bit flip or any other source of data corruption occurring during the dictionary transfer (e.g., from DRAM to the accelerator) or through an internal fault in the compression accelerator hardware/firmware resulting in corruption of the dictionary.

In some implementations, compression acceleration hardware may include logic (e.g., implemented in hardware circuitry or associated firmware) to perform a checksum calculation on the dictionary content itself and perform a comparison of the checksum with a provided checksum to verify that the dictionary about to be used in a compression or decompression operation is the same as that originally provided to the hardware. Such functionality may allow not only corruption in the target data to be detected (e.g., through a compress-and-verify operation (e.g., using a combination of a checksum calculated for the target data and errors calculated for the target data)), but also a dictionary used in compression or decompression of the data. In the event the calculated checksum is determined not to match a provided checksum for the dictionary, the accelerator may interrupt associated compression or decompression operations and return an error (e.g., to the application, prompting the application to resend or re-upload updated dictionary content), among other example implementations. The addition of a checksum-based error check of the dictionary content may guard against silent data corruption without impacting performance of the compression/decompression acceleration.

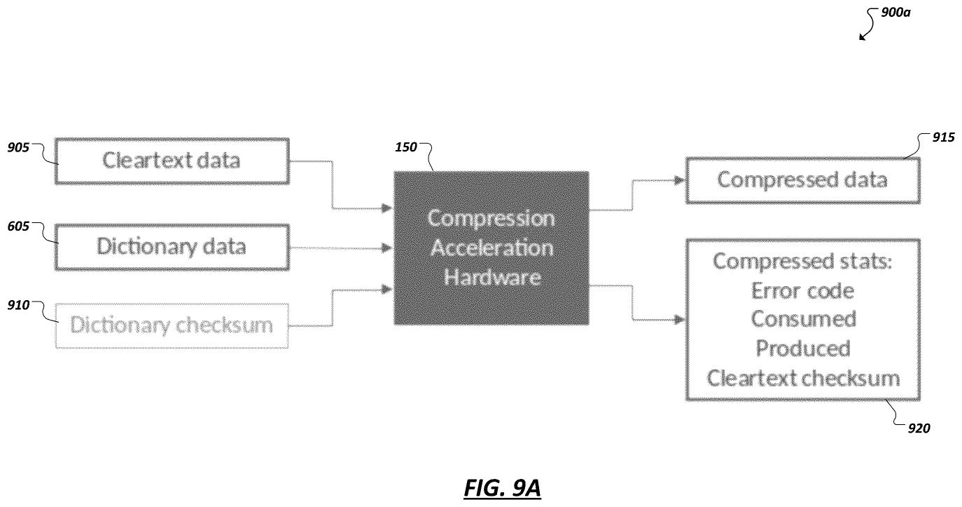

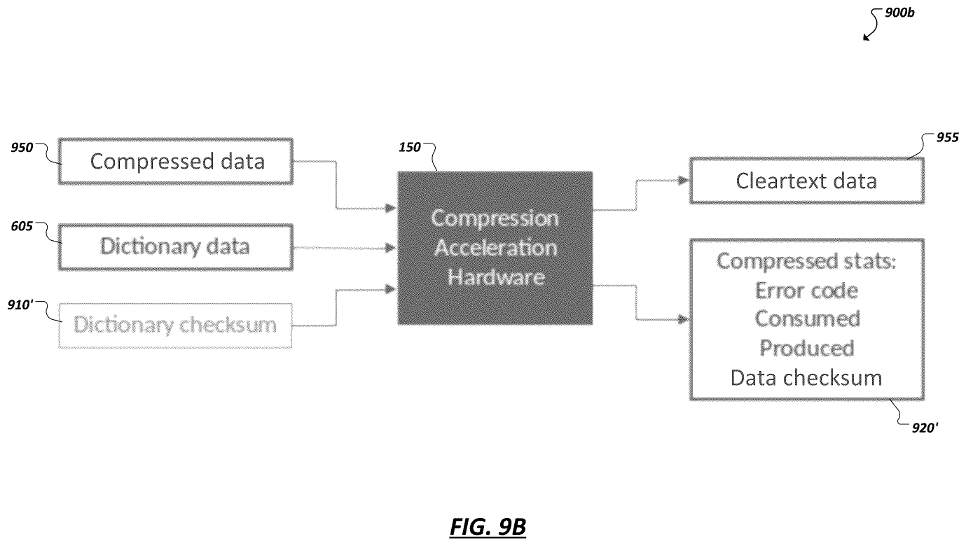

Turning to FIGS. 9A-9B, simplified block diagrams 900a-b are shown illustrating the provision of a dictionary 605 to example accelerator device 150. In the example of FIG. 9A, cleartext data 905 to be compressed by compression acceleration hardware 150 using a dictionary compression algorithm is provided to the compression acceleration hardware 150 along with the dictionary 605. An additional parameter, or data, that may be passed to the accelerator device 150 (e.g., utilizing an application programming interface (API), mailbox, or other delivery mechanism) may include a checksum 910 calculated for the dictionary content 605 (e.g., by the provider of the dictionary 605 (e.g., an application submitting the compression request to the accelerator device 150)). The accelerator device 150 may calculate its own checksum from the received dictionary data 605 and compare the calculated checksum against the provided checksum 910 to determine whether the dictionary data 605 is corrupt or not. In some implementations, the accelerator device 150 may support checksums generated according to multiple different algorithms (e.g., xxHash (e.g., xxHash32, xxHash64), Cyclical Redundancy Check (CRC) (e.g., CRC32, CRC32-C, CRC64), Adler, SHA-256, SHA3, etc.) and may identify (e.g., in metadata provided with the checksum 910) which checksum algorithm to use to generate its copy of the checksum. In some instances, the checksum algorithm may be inferred from the nature of the dictionary data or may be otherwise identified or identifiable from the request (e.g., with the requesting application providing a flag or other identifier in its request to indicate the checksum required). In other implementations, only a single checksum algorithm is supported and used by the accelerator (e.g., resulting in no need for a selection operation to determine which of multiple checksum algorithms to apply), among other example implementations. In some implementations, in addition to calculating checksums or hashes for dictionary content, accelerator hardware may perform similar checksum calculations on the target data (cleartext or compressed data) to detect bit errors in the target data, among other example features.

An example accelerator device may perform the calculation of a checksum or hash (collectively referred to herein as “checksum”) for the dictionary using hardware circuitry or firmware logic of the accelerator device. For instance, in some implementations, the checksum may be generated automatically by the accelerator device upon loading of the dictionary into a history buffer of the accelerator device. The accelerator device may additionally perform a comparison of its calculated checksum with a checksum received with the request (in hardware circuitry or firmware of the accelerator device). Upon performing the comparison, if no errors are found from the checksum comparison, the accelerator device 150 may determine that the dictionary 605 is error-free and proceed with performing compression operations on the cleartext data 905 using the dictionary 605 to generate a compressed data 915 output. In the event a mismatch between the calculated checksum and provided checksum is detected at the accelerator device, an error may be generated and indicated to the requesting application. In some cases, the requesting application, upon identifying that a dictionary error has occurred, may regenerate the request (e.g., with the same or an updated dictionary) and discard source data if any data was generated in this operation. In some implementations, additional statistical or reporting data (e.g., 920) may be generated in concert with a compression operation performed by the accelerator device on the cleartext 905 to describe attributes of the operation. For instance, statistics may include error codes (e.g., to identify whether or not an error was found in the dictionary 605 based on the checksum comparison), a record of the dictionary checksum calculated by the accelerator, the dictionary algorithm employed, an identifier of the dictionary, among other example information.

Turning to FIG. 9B, a diagram 900b is shown illustrating a counterpart example to the example of FIG. 9A, where instead of using accelerator device 150 to compress cleartext data using compression logic, decompression logic provided on the accelerator device 150 may be used to perform decompression of compressed data 950 using a dictionary-based decompression algorithm. As in the example of FIG. 9B, a dictionary 605 may be provided for use in decompressing compressed data 950, as well as a dictionary checksum 910′ (e.g., provided in association with a decompression request from an application (e.g., via an API)). The accelerator device 150 can calculate a checksum for the received dictionary 605 and perform a comparison of the calculated checksum with the provided checksum 910′ to determine whether the dictionary includes any bit errors. If the dictionary is verified to be error-free, the accelerator device 150 may use the dictionary to perform the decompression operation using the dictionary 605 to generate cleartext data 955 from the compressed data 950. In some implementations, statistic data or output metadata (e.g., 920′) may also be generated in association with decompression operations by the accelerator device 150 to identify any errors, the calculated dictionary checksum, a checksum for the cleartext or compressed data, etc.

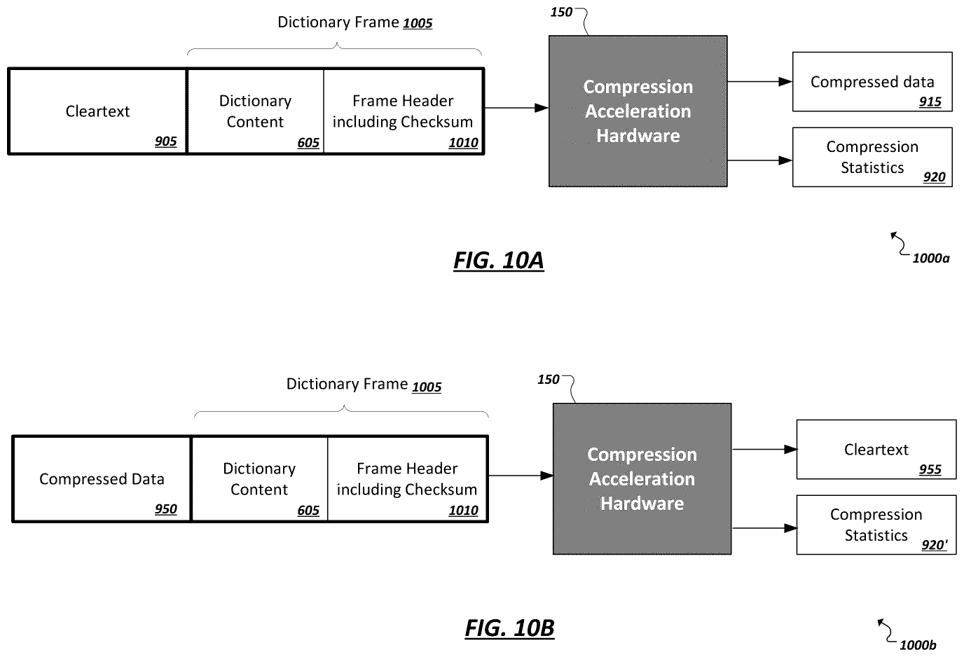

Turning to FIGS. 10A-10B, simplified block diagrams 1000a-b are shown illustrating an example implementation for delivering a dictionary checksum with dictionary data to a compression accelerator device (e.g., 150). In some implementations, a dictionary may be provided using a defined dictionary frame 1005. The dictionary frame 1005 may be according to a defined format (e.g., with defined fields, symbols, etc.), for instance, according to a defined protocol. The dictionary frame 1005 may include a dictionary frame header 1010 and the dictionary content 605. The dictionary frame 1005, in some implementations, may be provided with (e.g., appended to) cleartext (e.g., 905) or compressed data (e.g., 950) to be processed by the accelerator device 150 using a dictionary-based compression or decompression algorithm. The dictionary frame header 1010 may include a checksum previously calculated for the dictionary content 605 (among other example information). FIG. 10A shows an example where cleartext data 905 is provided with a dictionary frame 1005 in association with a request for the accelerator device 150 to perform a compression of the cleartext data 905 based on the dictionary 605 and generate corresponding compressed data 915. Prior to performing the compression, the accelerator device 150 may calculate its own instance of a checksum for the dictionary content 605 and perform a comparison of the calculated checksum with the checksum provided in the dictionary frame header 1010 to verify that the dictionary 605 is error-free. As in the example of FIG. 9A, statistics, log, or other data (e.g., 920) may be generated to document the performance of the compression, including whether an error occurred or was detected. Similarly, in the example of FIG. 10B, a dictionary frame 1005 is provided with dictionary 605 in association with a request to decompress compressed data 950 (e.g., provided with the dictionary frame 1005) to generate cleartext data 955. Before using the dictionary 605 to perform the decompression, the accelerator device 150 can perform a checksum comparison against the provided checksum in the dictionary frame header 1010 to confirm that the dictionary is not corrupted. With the dictionary 605 validated, the accelerator device 150 can perform the decompression operation to generate corresponding cleartext data 955 (and corresponding statistics data 920′).

Table 1 illustrates an example format of a dictionary frame. Given that the dictionary is known to the requester/application, the corresponding fields of the dictionary frame may be populated based on the dictionary. When an application sends a dictionary frame to the accelerator device in connection with a compression or decompression request, the accelerator device may identify the dictionary frame and its format from a magic number or other code. The accelerator device may then load the dictionary content included in the dictionary frame into its history buffer while computing the checksum for the dictionary.

TABLE 1
Example Dictionary Frame Format

| | | | |
|---|---|---|---|
| Magic Number | Checksum/Dictionary ID | Dictionary | Length (optional) |
| | | Content | |

In the example of Table 1, fields may include a Magic Number field, which provides a code to indicate that the data constitutes or includes a dictionary frame. In one example, the Magic Number may be defined as a 4-byte value. The dictionary frame format may be defined to correspond with or be compatible with a particular compression/decompression algorithm (e.g., ZSTD, Deflate, LZ4, LZ4s, Google™ Brotli™, among other examples). The dictionary frame may also include fields to deliver the dictionary content and the corresponding dictionary checksum. In one example, the dictionary checksum may be a 4-byte value. Assuming that this dictionary checksum value is unique (e.g., within a system) to a corresponding dictionary, in some instances, the dictionary checksum value can double as the identifier for the dictionary. Accordingly, a unique Checksum/Dictionary ID may serve as a foundation to support multiple dictionaries (e.g., concurrently) at the accelerator device. In some implementations, a separate dictionary ID field and value may be provided and included in the dictionary frame. Fields that do not include or that precede the actual dictionary content may be regarded as fields of a header of the dictionary frame. Other fields may also be included, such as a Length field (e.g., to indicate the byte length of the dictionary content or the entire dictionary frame). In other cases, the dictionary content length and/or dictionary frame length may be fixed (e.g., corresponding to a buffer length of the accelerator device), among other examples.

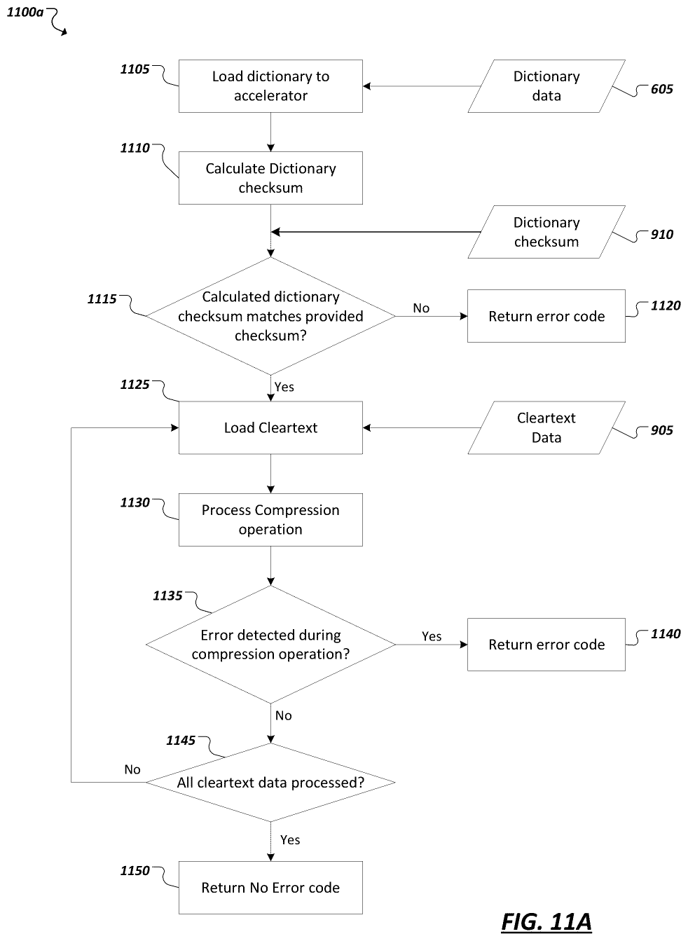

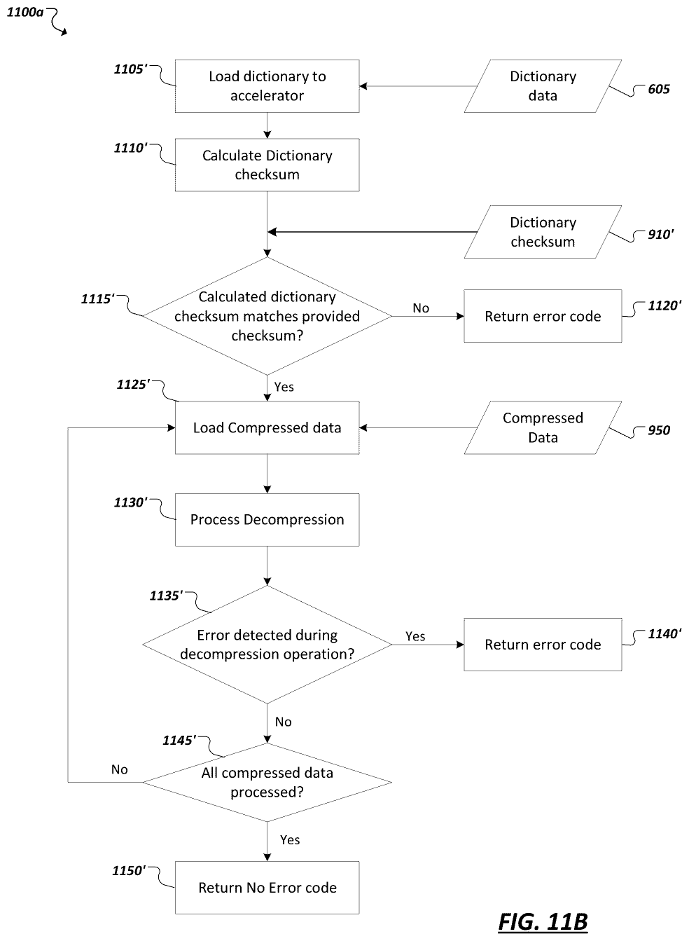

Turning to FIGS. 11A-11B, simplified flow diagrams 1100a-b are shown illustrating an example technique for performing error checks of dictionaries to be used by an accelerator device in a compression or decompression operation. In the example of FIG. 11A, a dictionary 605 is loaded 1105 to an accelerator device (e.g., in a history buffer of the accelerator device) in connection with a request submitted or routed to the accelerator device to compress particular cleartext data 905. A checksum 910 for the dictionary 605 may also be provided with the request (e.g., together with the dictionary or as a separate parameter) and the accelerator device may use the dictionary 605 to calculate 1110 afresh a checksum for the dictionary in accordance with an algorithm. Using the calculated checksum and the provided checksum 910, the accelerator device may perform a comparison of the checksums (e.g., 1115) to assess whether they match. If the checksums do not match, this indicates a bit error in the dictionary 605 and an error code may be returned 1120 to indicate the error. If the checksums match, the compression operation may continue at the accelerator device by loading 1125 the cleartext data 905 to be compressed using the dictionary 605 and performing the compression operation 1130. In some implementations, a validation operation may be performed to assess (at 1135) whether any errors occurred or were detected during the compression operation. Corresponding error codes may be returned 1140 to indicate whether (or not) an error was detected during compression. With the dictionary validated, further cleartext may be processed using the dictionary 605 in accordance with a request until it is determined (at 1145) that all of the target cleartext has been compressed. Where compression was successfully completed, a no error code may be returned 1150 to indicate the error-free completion of the compression in accordance with the request.

FIG. 11B is a simplified block diagram 1100b showing the counterpart technique for performing a validation of a dictionary 605, this time in association with a request to decompress compressed data 950 using a dictionary-based decompression operation performed by accelerator device. Similar to the example of FIG. 11A, a given dictionary (e.g., 605) associated or identified in a decompression request may be loaded 1105′ to the accelerator and dictionary checksum calculated 1110′ for the dictionary 605. This calculated checksum may be compared (at 1115′) against a provided dictionary checksum 910′ and error code returned 1120′ if the checksums do not match. The decompression can continue if the comparison shows that the checksums match, with compressed data 950 being loaded 1125′ to the accelerator and the decompression operation performed 1130′ using the verified dictionary 605. Errors may be detected 1135′ in association with the performance 1130′ of the decompression algorithm and reported (at 1140′). The accelerator device may continue to perform dictionary-based decompression using the verified dictionary 605 until it is determined 1145′ that all of the compressed data associated with the request has been successfully decompressed (which may be indicated through a no error signal returned 1150′ in association with completion of the decompression operations).

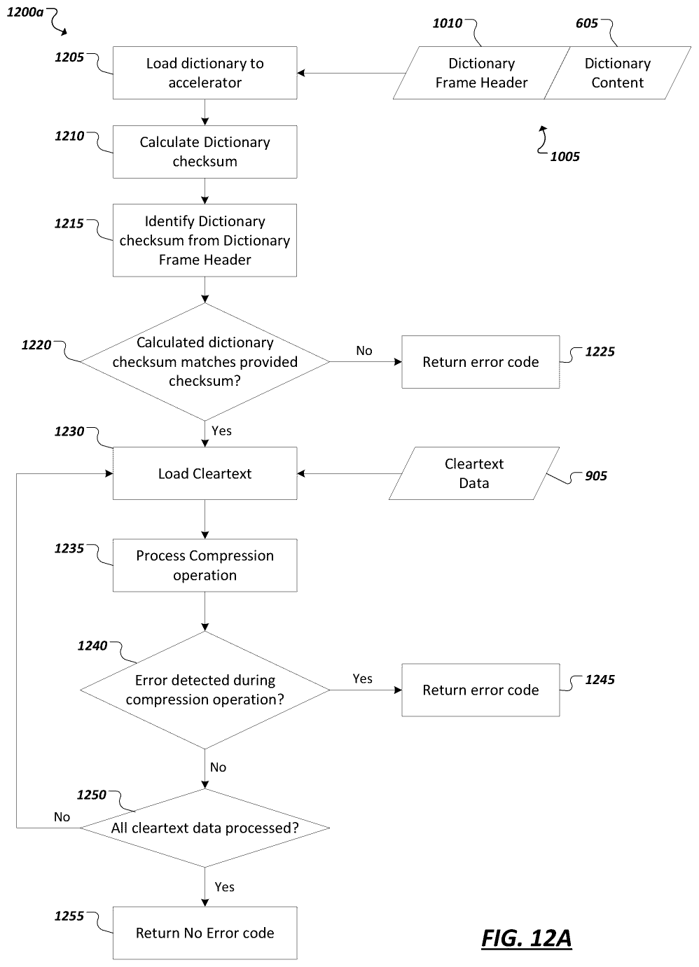

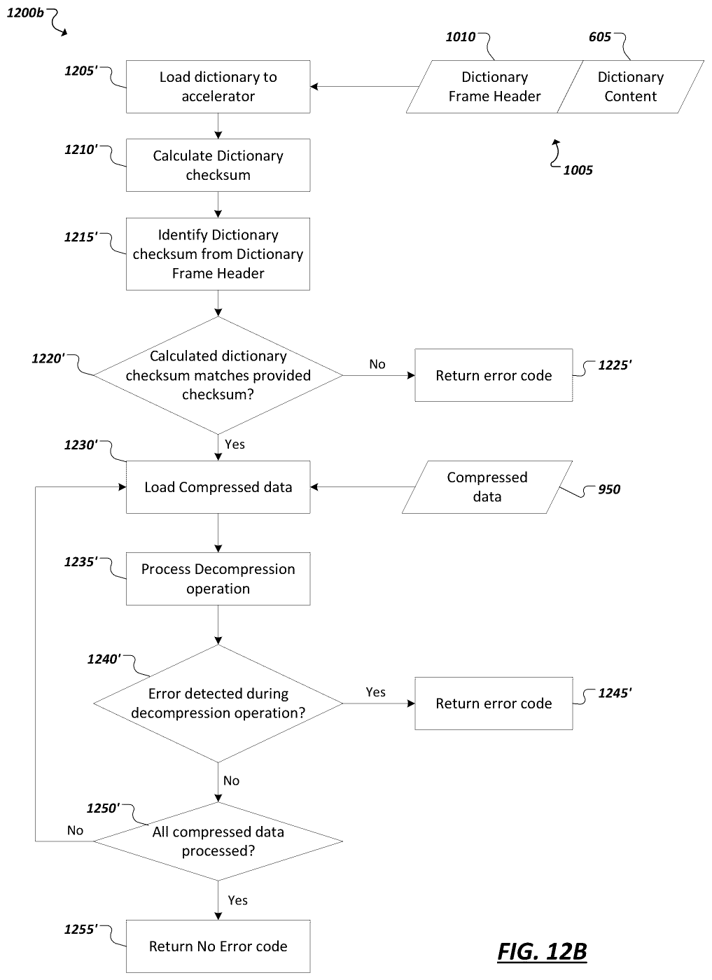

Turning to the examples of FIG. 12A-12B, further simplified flow diagrams 1200a-b are shown illustrating the performance of error checking of dictionary content in association with respective compression or decompression by an accelerator device. As introduced in the examples of FIGS. 10A-10B, in some implementations, a dictionary frame (e.g., 1005) may be utilized to not only provide the dictionary content 605 to the accelerator device, but also the associated checksum for the dictionary (as contained in the dictionary frame header 1110. For instance, FIG. 12A shows an example technique for performing compression of target cleartext data 905 using a dictionary 605 provided through a dictionary frame 1105. The dictionary frame 1005 may be received at the accelerator device and the dictionary content 605 identified and extracted from the dictionary frame and loaded 1205 (e.g., using a direct memory access write) to the accelerator. The accelerator device may calculate 1210 a checksum from the dictionary content 605 and further identify 1215 and extract the original checksum from the dictionary frame header 1010. The accelerator device may then compare 1220 the calculated checksum with the extracted checksum to determine whether there are errors in the dictionary 605. If the checksums do not match, this indicates a bit error in the dictionary 605 and an error code may be returned 1225 to indicate the error. If the checksums match, the compression operation may continue at the accelerator device by loading 1230 the target cleartext data 905 to the accelerator device and performing the compression operation 1235 using the dictionary 605. Error detection may be performed 1135 to detect any errors that might have occurred during the compression operation 1235 and any detected errors may be reported (at 1245). With the dictionary validated, further cleartext may be processed using the dictionary 605 in accordance with a request until it is determined (at 1250) that all of the target cleartext has been compressed. Upon successful, error-free completion of the compression of the target data, a no error code may be returned 1255 (e.g., to the application, which requested the compression using the dictionary).

FIG. 12B illustrates the analogue to FIG. 12A, where decompression is performed instead of compression. Again, in the example of FIG. 12B, a dictionary frame 1005 may be utilized (e.g., sent in connection with a decompression request) that includes the dictionary 605 to be used and a checksum for the dictionary (as included in the dictionary frame header 1010). The dictionary may be identified within the dictionary frame and loaded 1205′ to the accelerator device and the accelerator device may calculate 1210′ a checksum for the dictionary 605. The accelerator device may also extract or be loaded with (at 1220′) the checksum from the dictionary frame and validate the dictionary 605 by comparing 1220′ the calculated checksum with the checksum from the dictionary header. If a mismatch is detected, an error may be returned 1225′ (e.g., to the requesting application). The decompression can continue if the comparison shows that the checksums match, with compressed data 950 being loaded 1230′ to the accelerator device and the decompression operation performed 1235′ using the verified dictionary 605. Errors may be detected 1240′ in association with the performance 1235′ of the decompression algorithm and reported (at 1245′). The accelerator device may continue to perform dictionary-based decompression using the verified dictionary 605 until it is determined 1250′ that all of the compressed data associated with the request has been successful decompressed, which may result in a no error signal being returned 1150′ in association with completion of the decompression operations (e.g., to acknowledge completion of the same to the requesting application), among other example features and implementations.

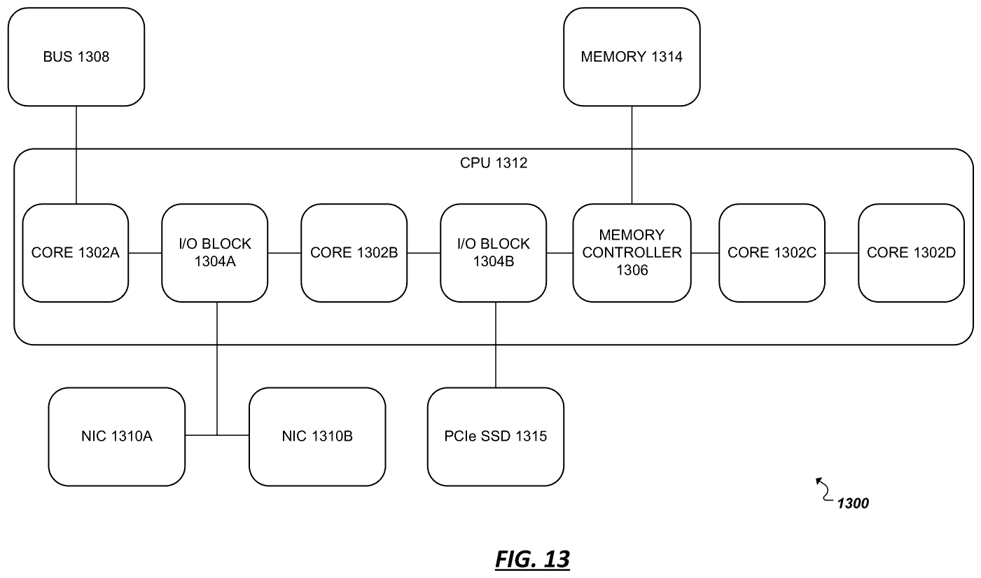

Note that the apparatus', methods', and systems described above may be implemented in any electronic device or system as aforementioned. More particularly, a preprocessing hardware accelerator, such as discussed herein, may be coupled to or integrated in a variety of different electronic devices or system to offload certain preprocessing tasks, including data reduction operations, from other processing hardware (e.g., a CPU) of the system. As a specific illustration, FIG. 13 provides an exemplary implementation of a processing device such as one that may be included or be coupled to and use a preprocessing hardware accelerator (e.g., to offload workloads to). It should be appreciated that other processor architectures may be provided to implement the functionality and processing of requests by an example network processing device, including the implementation of the example network processing device components and functionality discussed above. Further, while the examples discussed above focus on improvements to an Ethernet subsystem and links compliant with an Ethernet-based protocol, it should be appreciated that the principles discussed herein are protocol agnostic and may be applied to interconnects based on a variety of other technologies, such as PCIe, CXL, UCIe, CCIX, Infinity Fabric, among other examples.

Referring to FIG. 13, a block diagram 1300 is shown of an example data processor device (e.g., a central processing unit (CPU)) 1312 coupled to various other components of a platform in accordance with certain embodiments. Although CPU 1312 depicts a particular configuration, the cores and other components of CPU 1312 may be arranged in any suitable manner. CPU 1312 may comprise any processor or processing device, such as a microprocessor, an embedded processor, a digital signal processor (DSP), a network processor, an application processor, a co-processor, a system on a chip (SOC), or other device to execute code. CPU 1312, in the depicted embodiment, includes four processing elements (cores 1302 in the depicted embodiment), which may include asymmetric processing elements or symmetric processing elements. However, CPU 1312 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 1312, as illustrated in FIG. 13, includes four cores-cores 1302A, 1302B, 1302C, and 1302D, though a CPU may include any suitable number of cores. Here, cores 1302 may be considered symmetric cores. In another embodiment, cores may include one or more out-of-order processor cores or one or more in-order processor cores. However, cores 1302 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 1302 may include a decode module coupled to a fetch unit to decode fetched elements. Fetch logic, in one embodiment, includes individual sequencers associated with thread slots of cores 1302. Usually a core 1302 is associated with a first ISA, which defines/specifies instructions executable on core 1302. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 1302 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 1302, in one embodiment, recognize the same ISA (or a subset thereof). Alternatively, in a heterogeneous core environment, a decoder of one or more cores (e.g., core 1302B) may recognize a second ISA (either a subset of the first ISA or a distinct ISA).

In various embodiments, cores 1302 may also include one or more arithmetic logic units (ALUs), floating point units (FPUs), caches, instruction pipelines, interrupt handling hardware, registers, or other suitable hardware to facilitate the operations of the cores 1302.

Bus 1308 may represent any suitable interconnect coupled to CPU 1312. In one example, bus 1308 may couple CPU 1312 to another CPU of platform logic (e.g., via UPI). I/O blocks 1304 represents interfacing logic to couple I/O devices 1310 and 1315 to cores of CPU 1312. In various embodiments, an I/O block 1304 may include an I/O controller that is integrated onto the same package as cores 1302 or may simply include interfacing logic to couple to an I/O controller that is located off-chip. As one example, I/O blocks 1304 may include PCIe interfacing logic. Similarly, memory controller 1306 represents interfacing logic to couple memory 1314 to cores of CPU 1312. In various embodiments, memory controller 1306 is integrated onto the same package as cores 1302. In alternative embodiments, a memory controller could be located off chip.

As various examples, in the embodiment depicted, core 1302A may have a relatively high bandwidth and lower latency to devices coupled to bus 1308 (e.g., other CPUs 1312) and to NICs 1310, but a relatively low bandwidth and higher latency to memory 1314 or core 1302D. Core 1302B may have relatively high bandwidths and low latency to both NICs 1310 and PCIe solid state drive (SSD) 1315 and moderate bandwidths and latencies to devices coupled to bus 1308 and core 1302D. Core 1302C would have relatively high bandwidths and low latencies to memory 1314 and core 1302D. Finally, core 1302D would have a relatively high bandwidth and low latency to core 1302C, but relatively low bandwidths and high latencies to NICs 1310, core 1302A, and devices coupled to bus 1308.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, HDL, and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of a system on chip (SoC) and other hardware devices. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, such as reset, while an updated value potentially includes a low logical value, such as set. Note that any combination of values may be utilized to represent any number of states.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: an interface to couple to a processor device and receive, from an application run on the processor device, a request to compress target data, where the request identifies a dictionary; and one or more compression hardware blocks to perform a dictionary compression to compress the target data based on the request, where the dictionary is used in the dictionary compression.

Example 2 includes the subject matter of example 1, where the request includes a pointer to identify a location in a memory of the dictionary, and the apparatus includes internal memory and is to load the dictionary from the memory to the internal memory for use in the dictionary compression.

Example 3 includes the subject matter of example 2, where the request further includes a pointer to identify a memory location for the target data, and the apparatus is to load the target data from the memory location to the internal memory for use in the dictionary compression.

Example 4 includes the subject matter of example 2, where the dictionary is loaded from the memory through a direct memory access (DMA) transaction.

Example 5 includes the subject matter of any one of examples 1-4, where the request is sent over an application programming interface (API) associated with the apparatus.

Example 6 includes the subject matter of any one of examples 1-5, where the dictionary compression of the target data generates compressed target data, and the compressed target data is sent to the processor device over the interface.

Example 7 includes the subject matter of any one of examples 1-6, further including processing circuitry to execute firmware to cause the dictionary compression to be performed with the one or more compression hardware blocks.

Example 8 includes the subject matter of any one of examples 1-7, where the request identifies a particular one of a plurality of compression algorithms, the dictionary compression includes the particular compression algorithm with use of the dictionary, and the one or more compression hardware blocks are configurable to perform the plurality of compression algorithms.

Example 9 includes the subject matter of any one of examples 1-8, further including one or more decompression hardware blocks to perform a dictionary decompression.

Example 10 includes the subject matter of example 9, where a decompression request is to be received over the interface and the decompression hardware blocks use the dictionary to perform decompression of compressed data identified in the decompression request.

Example 11 includes the subject matter of example 9, where a verification of the dictionary compression is to be performed using one or more of the decompression hardware blocks prior to sending results of the dictionary compression.

Example 12 includes the subject matter of example 11, where the verification includes: determining a checksum value for the target data; compressing the target data using the dictionary compression to generate compressed target data; providing the compressed target data to the one or more decompression hardware blocks; performing dictionary decompression of the compressed target data using the dictionary to generate decompressed data; determining a checksum value of the decompressed data; and comparing the checksum value of the target data with the checksum value of the decompressed data.

Example 13 is a method including: receiving, from an application executed on a processor device, a compression acceleration request at a hardware accelerator device coupled to the processor device, where the compression acceleration request identifies a dictionary to be applied in a compression of particular target data; loading the dictionary and the particular target data in internal memory of the hardware accelerator device; performing hardware compression of the target data using the dictionary and circuitry of the hardware accelerator device to compress the particular target data in accordance with a dictionary compression algorithm; and passing the compressed particular target data from the hardware accelerator device to the processor device.

Example 14 includes the subject matter of example 13, further including: receiving a decompression request at the hardware accelerator device to decompress compressed data using dictionary decompression, where the decompression request identifies a corresponding dictionary to be applied in the dictionary decompression; and decompressing the compressed data using the corresponding dictionary and circuitry of the hardware accelerator device.

Example 15 includes the subject matter of example 13, further including performing a verification of compression of the particular target data based on a decompression of the compressed particular target data performed using decompression hardware of the hardware accelerator device.

Example 16 is a system including means to perform the method of any one of examples 13-15.

Example 17 is a system including: a processor device to execute an application; a hardware accelerator device including: an interface to couple to a processor device and receive, from the application, a request to compress target data, where the request identifies a dictionary; and one or more compression hardware blocks to perform a dictionary compression to compress the target data based on the request, where the dictionary is used in the dictionary compression

Example 18 includes the subject matter of example 17, where the hardware accelerator device is coupled to a plurality of processors to service offload requests to accelerate data compression using one or more hardware-implemented dictionary compression algorithms.

Example 19 includes the subject matter of any one of examples 17-18, where the processor device and hardware accelerator device are components of a system on chip (SoC) device.

Example 20 includes the subject matter of any one of examples 17-19, where the request includes a pointer to identify a location in a memory of the dictionary, and the system includes internal memory and is to load the dictionary from the memory to the internal memory for use in the dictionary compression.

Example 21 includes the subject matter of example 20, where the request further includes a pointer to identify a memory location for the target data, and the system is to load the target data from the memory location to the internal memory for use in the dictionary compression.

Example 22 includes the subject matter of example 20, where the dictionary is loaded from the memory through a direct memory access (DMA) transaction.

Example 23 includes the subject matter of any one of examples 17-22, where the request is sent over an application programming interface (API) associated with the system.

Example 24 includes the subject matter of any one of examples 17-23, where the dictionary compression of the target data generates compressed target data, and the compressed target data is sent to the processor device over the interface.

Example 25 includes the subject matter of any one of examples 17-24, further including processing circuitry to execute firmware to cause the dictionary compression to be performed with the one or more compression hardware blocks.

Example 26 includes the subject matter of any one of examples 17-25, where the request identifies a particular one of a plurality of compression algorithms, the dictionary compression includes the particular compression algorithm with use of the dictionary, and the one or more compression hardware blocks are configurable to perform the plurality of compression algorithms.

Example 27 includes the subject matter of any one of examples 17-26, further including one or more decompression hardware blocks to perform a dictionary decompression.

Example 28 includes the subject matter of example 27, where a decompression request is to be received over the interface and the decompression hardware blocks use the dictionary to perform decompression of compressed data identified in the decompression request.

Example 29 includes the subject matter of example 27, where a verification of the dictionary compression is to be performed using one or more of the decompression hardware blocks prior to sending results of the dictionary compression.

Example 30 includes the subject matter of example 29, where the verification includes: determining a checksum value for the target data; compressing the target data using the dictionary compression to generate compressed target data; providing the compressed target data to the one or more decompression hardware blocks; performing dictionary decompression of the compressed target data using the dictionary to generate decompressed data; determining a checksum value of the decompressed data; and comparing the checksum value of the target data with the checksum value of the decompressed data.

Example 31 includes the subject matter of any one of examples 1-12, further including error detection logic to: identify a received checksum for the dictionary; calculate a dictionary checksum for the dictionary; and compare the received checksum with the dictionary checksum to determine whether bit errors are present in the dictionary.

Example 32 includes the subject matter of example 31, where the dictionary and the received checksum are included in a dictionary frame.

Example 33 includes the subject matter of any one of examples 31-32, where the dictionary compression is performed based on determining that no bit errors are present in the dictionary.

Example 34 includes the subject matter of any one of examples 13-15, further including: identifying a received checksum for the dictionary; calculating a dictionary checksum for the dictionary; and comparing the received checksum with the dictionary checksum to determine whether bit errors are present in the dictionary.

Example 35 includes the subject matter of any one of examples 17-30, where the hardware accelerator device further includes: error detection logic to: identify a received checksum for the dictionary; calculate a dictionary checksum for the dictionary; and compare the received checksum with the dictionary checksum to determine whether bit errors are present in the dictionary.

Example 36 includes the subject matter of example 35, wherein the dictionary and the received checksum are included in a dictionary frame.

Example 37 includes the subject matter of any one of examples 35-36, where the dictionary compression is performed based on determining that no bit errors are present in the dictionary.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplary language does not necessarily refer to the same embodiment or the same example, but may refer to different and distinct embodiments, as well as potentially the same embodiment.

What is claimed is:

1. An apparatus comprising:
an interface to couple to a processor device and receive a request to compress target data associated with a software application run on the processor device, wherein the request identifies a dictionary and a particular one of a plurality of compression algorithms; and
one or more compression hardware blocks to perform a dictionary compression to compress the target data based on the request, wherein the dictionary is used with the particular compression algorithm in the dictionary compression, and the one or more compression hardware blocks are configurable to perform any one of the plurality of compression algorithms.

2. The apparatus of claim 1, further comprising accelerator memory, wherein the request comprises a pointer to identify a location of the dictionary in a memory associated with the processor device, and the apparatus further comprises circuitry to load the dictionary from the memory to the accelerator memory for use in the dictionary compression.

3. The apparatus of claim 2, wherein the request further comprises an identifier of a location in the memory for the target data, and the apparatus comprises circuitry to load the target data from the memory location to the accelerator memory for use in the dictionary compression.

4. The apparatus of claim 2, wherein the dictionary is loaded from the memory through a direct memory access (DMA) transaction.

5. The apparatus of claim 1, wherein the request is sent over an application programming interface (API) associated with the apparatus.

6. The apparatus of claim 1, wherein the dictionary compression of the target data generates compressed target data, and the compressed target data is sent to the processor device over the interface.

7. The apparatus of claim 1, further comprising processing circuitry to execute firmware to cause the dictionary compression to be performed with the one or more compression hardware blocks.

8. The apparatus of claim 1, further comprising one or more decompression hardware blocks to perform a dictionary decompression, wherein a decompression request is to be received over the interface and the decompression hardware blocks use the dictionary to perform decompression of compressed data identified in the decompression request.

9. The apparatus of claim 8, wherein a verification of the dictionary compression is to be performed using one or more of the decompression hardware blocks prior to sending results of the dictionary compression, wherein the verification comprises:
determining a checksum value for the target data;
compressing the target data using the dictionary compression to generate compressed target data;
providing the compressed target data to the one or more decompression hardware blocks;
performing dictionary decompression of the compressed target data using the dictionary to generate decompressed data;
determining a checksum value of the decompressed data; and
comparing the checksum value of the target data with the checksum value of the decompressed data.

10. The apparatus of claim 1, further comprising error detection circuitry to:
identify a received checksum for the dictionary;
calculate a dictionary checksum for the dictionary; and
compare the received checksum with the dictionary checksum to determine whether bit errors are present in the dictionary.

11. The apparatus of claim 10, wherein the dictionary and the received checksum are included in a dictionary frame.

12. The apparatus of claim 10, wherein the error detection circuitry is further to generate compression statistic data in association with performance of the dictionary compression, wherein the statistic data describe attributes of the performance of the dictionary compression, and the attributes comprise the calculated dictionary checksum.

13. A method comprising:
receiving, from an application executed on a processor device, a compression acceleration request at a hardware accelerator device coupled to the processor device, wherein the compression acceleration request identifies a dictionary to be applied in a compression of particular target data;
loading the dictionary and the particular target data in internal memory of the hardware accelerator device; and
performing hardware compression of the target data using the dictionary and circuitry of the hardware accelerator device to compress the particular target data in accordance with a dictionary compression algorithm; and
passing the compressed particular target data from the hardware accelerator device to the processor device.

14. The method of claim 13, further comprising:
receiving a decompression request at the hardware accelerator device to decompress compressed data using dictionary decompression, wherein the decompression request identifies a corresponding dictionary to be applied in the dictionary decompression; and
decompressing the compressed data using the corresponding dictionary and circuitry of the hardware accelerator device.

15. The method of claim 13, further comprising:
identifying a received checksum for the dictionary;
calculating a dictionary checksum for the dictionary; and
comparing the received checksum with the dictionary checksum to determine whether bit errors are present in the dictionary.

16. A system comprising:
a processor device to execute an application;
a hardware accelerator device comprising:
an interface to couple to a processor device and receive, from the application, a request to compress target data, wherein the request identifies a dictionary; and
one or more compression hardware blocks to perform a dictionary compression to compress the target data based on the request, wherein the dictionary is used in the dictionary compression.

17. The system of claim 16, wherein the hardware accelerator device is coupled to a plurality of processors to service offload requests to accelerate data compression using one or more hardware-implemented dictionary compression algorithms.

18. The system of claim 16, wherein the processor device and hardware accelerator device are components of a system on chip (SoC) device.

19. The system of claim 16, wherein the request identifies a particular one of a plurality of compression algorithms, the dictionary compression comprises the particular compression algorithm with use of the dictionary, and the one or more compression hardware blocks are configurable to perform the plurality of compression algorithms.

20. The system of claim 16, wherein the hardware accelerator device further comprises:
error detection circuitry to:
identify a received checksum for the dictionary;
calculate a dictionary checksum for the dictionary; and
compare the received checksum with the dictionary checksum to determine whether bit errors are present in the dictionary, wherein the dictionary and the received checksum are included in a dictionary frame.
